(19) United States
(12) Patent Application Publication
(10) Pub. No.: US 2012/0047583 A1
(43) Pub. Date: Feb. 23, 2012

(54) CABLE FRAUD DETECTION SYSTEM

(76) Inventors: Nsirim L. Nyemahame, Alpharetta, GA (US); Jeff Burgett, Alpharetta, GA (US)

(21) Appl. No.: 13/215,201

(22) Filed: Aug. 22, 2011

Related U.S. Application Data
(60) Provisional application No. 61/375,290, filed on Aug. 20, 2010.

(51) Int. Cl. H04N 7/16

(52) U.S. Cl. 726/26

(57) ABSTRACT

Embodiments of the present disclosure provide constant support against fraudulent cable devices maintaining unauthorized connectivity and utilizing data lines illegally within an entire network regardless of the number of DHCP servers. Embodiments maintain an updated database which is mined for duplicate MAC (Media Access Control) addresses and utilizes the assigned IPs to communicate with the devices via Simple Network Management Protocol (SNMP) comparing their system description Object Identifier (OID) value with the stored value located in the device Management Information (MI) database. When a fraudulent device is found, a series of events is triggered which discontinues service as well as bans the fraudulent device from reconnecting to the network.

### CLAIM OF PRIORITY

This application claims the benefit of priority from U.S. Provisional Patent Application Ser. No. 61/375,290 filed on Aug. 20, 2010 and entitled “Cable Fraud Detection System,” which is fully incorporated herein by reference for all purposes.

### FIELD

Embodiments of the present disclosure generally relate to a method and apparatus for network management and, more particularly, to an improved system of establishing the validity of networked devices by detecting cable modems and cable network devices with duplicate media access controller (MAC) addresses.

### BACKGROUND

Every network interface has a MAC address, also known as the physical address. This is the actual hardware address that the lowest level of the network uses to communicate. In cable networks, the MAC address is used to assign an Internet protocol (IP) address to a device by means of a dynamic host configuration protocol (DHCP) server. The MAC address is theoretically unique to a particular device enabling an IP network service provider to use the MAC address as a vehicle for authorizing access to its network and further aids in billing users for services.

A cable network comprises a variety of cable network devices, including cable modems (CMs) and cable modem auxiliary devices (CMADs) such as multimedia terminal adapters (MTAs) and two-way set top boxes (STBs). Each of these devices is assigned an IP address by the cable network based on the MAC address of the device. Ideally, at the time of manufacture, each cable network device (e.g., a CM, MTA, set top box among others) is assigned a MAC address that uniquely identifies that device. Either through error at the time of manufacture, or through malicious intent (hacking), a cable network device may appear on a cable network with a MAC address that has already been assigned to another cable network device. As the MAC address is often the sole identifier used to identify and authenticate a cable network device for network connectivity, programming delivery and billing purposes, it is imperative to guarantee the uniqueness of the MAC address for each cable network device in order to thwart “theft of services.”

The consequences of allowing cable network devices with duplicate MAC addresses to operate on a cable network can be significant. If a “rogue” cable modem, MTA or other cable network device were to share the same MAC address as a legitimate cable network device, the “rogue” device would receive the same service as the legitimate device. If the legitimate device user is charged for service based upon the quantity of service used, it is likely that the legitimate user will be charged for the services utilized by the “rogue” device. Resolving payment disputes is costly for the cable service provider and, at a minimum, annoying and inconvenient for their subscribers.

What is needed are means for identifying cable network devices having the same MAC address on one or more cable modem termination systems (CMTSs), either as part of single network or as part of multiple networks within a cable network.

### SUMMARY

Certain embodiments provide a method for network cable fraud detection. The method generally includes receiving via a network an authorized customer premises equipment (CPE) provisioning request, storing a set of CPE information of an authorized CPE from the provisioning request in a management information database of the network, comparing at least one element of the set of authorized CPE information of CPEs active on the network, determining if there are CPEs active on the network with duplicate CPE information, comparing a system description object identifier (OID) of authorized CPEs to a system description OID for each CPEs active on the network with duplicate CPE information, and discontinuing data service to each CPEs in which the system description OID does not match the system description object identifier (OID) of authorized CPEs.

Certain embodiments provide a computer program product for detecting network cable fraud, the computer-program product including a computer readable medium having instructions thereon. The instructions generally include instructions for receiving via a network an authorized customer premises equipment (CPE) provisioning request, instructions for storing a set of CPE information of an authorized CPE from the provisioning request in a management information database of the network, instructions for comparing at least one element of the set of authorized CPE information of CPEs active on the network, instructions for determining if there are CPEs active on the network with duplicate CPE information, instructions for comparing a system description object identifier (OID) of authorized CPEs to a system description OID for each CPEs active on the network with duplicate CPE information, and instructions for discontinuing data service to each CPEs in which the system description OID does not match the system description object identifier (OID) of authorized CPEs.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 is a diagram of a communication system employing a fraud detection system for supporting remote access services, according to an embodiment of the present invention.

FIG. 2 is another diagram illustrating the relationship between CPE and ISP equipment employing a fraud detection system.

FIG. 3 is a block diagram illustrating a plurality of steps in an exemplary process of detecting and preventing cable fraud.

### DETAILED DESCRIPTION

In the cable environment, access to the cable network's data service is provided to cable modem auxiliary devices (CMADs) through a cable modem (CM). Increasingly, CMs are required to comply with an industry standard referred to as the “Data Over Cable Service Interface Specification” or DOCSIS. DOCSIS provides a set of standards and a certifying authority by which cable companies can achieve cross-platform functionality in Internet delivery. A DOCSIS compliant cable network comprises cable modem termination systems (CMTSs) and cable modems that form the interface to an Internet service provider (ISP). The CM provides two-way connectivity between a customer and the ISP through the CMTS by exchanging digital signals with CMs on a cable network.

High-speed data, including cable TV, internet, and voice service, may be delivered to a subscriber through channels in a coaxial cable to a CM. An upstream channel is used to communicate from the CM to the CMTS, while a downstream channel handles communication from the CMTS to the CM. When a CMTS receives signals from the CM, the CMTS converts these signals into Internet Protocol (IP) packets, which are then sent to an IP router for transmission across a managed IP network. When a CMTS sends signals to a cable modem, the CMTS modulates the downstream signals for transmission across the cable to the CM.

CMTS is equipment typically located in a cable company's headend or hubsite and used to provide high speed data services, such as cable internet or Voice over IP (VoIP), to cable subscribers. A typical CMTS allows a subscriber's computer to obtain an IP address by forwarding one or more DHCP requests to the relevant servers. The CMTS may also implement some basic filtering to protect against unauthorized users and various attacks. Traffic shaping is sometimes performed to prioritize application traffic, perhaps based upon subscribed plan or download usage. However, the function of traffic shaping is more likely done by a policy traffic switch. A CMTS may also act as a bridge or router.

To comply with DOCSIS, each of these devices is assigned an IP address by the cable network based on the MAC address of the device. Ideally, at the time of manufacture, each cable network device (e.g., a CM, MTA, set top box among others) is assigned a MAC address that uniquely identifies that device. Either through error at the time of manufacture, or through malicious intent (hacking), a cable network device may appear on a cable network with a MAC address that has already been assigned to another cable network device. As the MAC address is often the sole identifier used to identify and authenticate a cable network device for network connectivity, programming delivery and billing purposes, it is imperative to guarantee the uniqueness of the MAC address for each cable network device in order to thwart “theft of services.”

A cable network in which a single DHCP server supports a CMTS provides some level of protection against duplication of MAC addresses by CMs. CMs are identified to the cable network through an initialization process managed by the CMTS. The CM is initialized with the CMTS through a series of handshakes that comprise an exchange of data. When a CM is powered on, it scans the cable network for a downstream data channel carrying a signal that the CM recognizes as coming from the CMTS. The signal from the CMTS comprises an instruction set used by the CM module to communicate with the CMTS. The CM receives and implements the instruction set and then obtains from the CMTS parameters concerning available upstream channels on which the device may transmit. Other operational parameters are acquired and the CM is registered on the cable network.

In this provisioning example, the CM sends a dynamic host configuration protocol (DHCP) request to the CMTS for an IP address and other parameters. The IP address enables the CM to establish its identity for receiving the downstream data addressed to it and for transmitting data from a known Internet address. The request includes the MAC address of the CM. If the MAC address of the CM is not associated with a previously registered CM, the CMTS forwards the CM's request for the IP address to the DHCP server assigned to that CMTS. This server contains a database or pool of IP addresses allocated to the Internet devices on the network. The DHCP server responds through the CMTS with an IP address and other necessary data. The CM extracts this data from the message and immediately configures its IP parameters.

The CMTS maintains a list of CM MAC addresses for CMs that are currently registered with the CMTS. If a CM is registered and another CM with the same MAC address as the first CM attempts to register with that CMTS, the CMTS will typically reject the second CM's registration attempt. Note, there is no mechanism for the CMTS to determine which of the CMs is the “rightful owner” of the CM MAC address, it can only determine that a CM is attempting to register with a MAC address with which another CM is currently registered.

The provisioning process for CMAD (e.g., an MTA) differs from the process experienced by the CM in that the CMAD provisioning is not managed by the CMTS and the CMAD is not registered with the CMTS before presenting its MAC address to a DHCP server. Rather, the CMAD is provisioned after the CM has been authorized by the CMTS and assigned an IP address by the DHCP server. For example, two MTAs presenting the same MTA MAC address via different CMs presenting different and valid CM MAC addresses will not be detected by the CMTS. As noted, the DHCP request from the MTA comprises the MAC address of the MTA and the MAC address of the CM to which the MTA is connected. It has been suggested that the MTA MAC address be associated with the CM MAC address to detect use of a single MTA with multiple CMs. No specific implementations of this suggestion have been found. Even if implemented, this association does not address the problem of detecting unauthorized MTA usage when the cable network comprises multiple CMTSs or multiple smaller networks each with its own CMTS and DHCP server support.

Embodiments of the present disclosure provide constant support against fraudulent cable devices maintaining unauthorized connectivity and utilizing data lines illegally within an entire network regardless of the number of DHCP servers. Embodiments maintain an updated database which is mined for duplicate MAC (Media Access Control) addresses and utilizes the assigned IPs to communicate with the devices via Simple Network Management Protocol (SNMP) comparing their system description Object Identifier (OID) value with the stored value located in the device Management Information (MI) database. When a fraudulent device is found, a series of events is triggered which discontinues service as well as bans the fraudulent device from reconnecting to the network.

### An Examplary Cable Fraud Detection System

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

A system, method, and software for detecting fraudulent use of data communication services are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is described with respect to specific examples of networks and protocols, such as an IP-based network and an X.25 network, it is contemplated that other equivalent communication networks and protocols can be utilized.

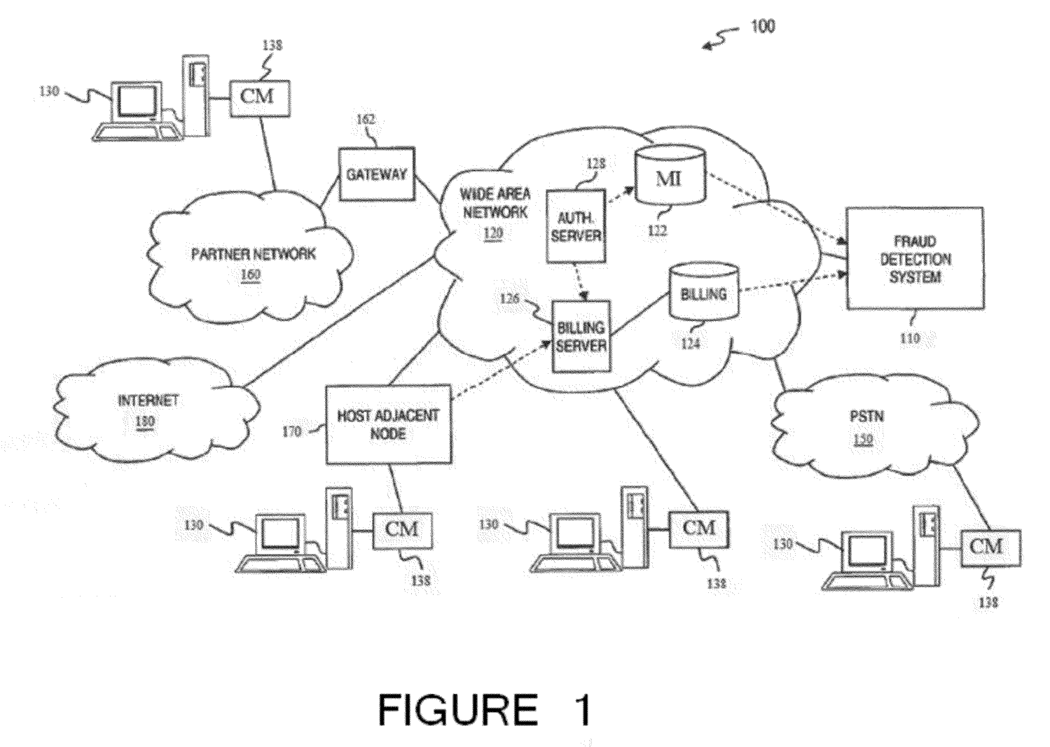

FIG. 1 is a diagram of a communication system employing a fraud detection system for supporting remote access services, according to an embodiment of the present invention. A data communication system 100 includes a fraud detection system (or fraud monitoring system) 110 that receives data files relating to monitored activities from a Wide Area Network (WAN) network 120. In particular, the WAN 120 houses data collection databases 122, 124 that store the data files, which can retrieved by the fraud detection system 110, for example. Alternatively, the data files can be streamed for more expedient delivery of the information. The databases 122, 124 may include a Management Information (MI) database 122 and a billing database 124, respectively. The MI database 122 may store the IP address, MAC address, CMTS IP address, domain name of the CMTS, or any other relevant device management information, or any combination thereof for each of the cable based devices attached to the network. The billing database 124 may communicate with a billing server 126 that generates billing data relating to the communication sessions supported across the WAN 120. The billing server 126 may also have connectivity to an authentication server 128, which regulates, in part, the login procedures for remote access to the WAN 120. The term “remote access” refers to the communication with the authentication server 128 for access to the resource of the WAN 120; exemplary remote access mechanisms include dial-up access using a telephone connection.

As seen in FIG. 1, the WAN 120 can be accessed by a number of end users via hosts 130 through a variety of networks and nodes and corresponding access equipment 138 which can include a cable modem (CM), a network interface card (NIC) coupled to an access device or other customer premises equipment (CPE), etc. depending on the particular network (e.g., Digital Subscriber Line (DSL) network, cable network, telephone network, etc.). For example, such networks can include a public switched telephone network (PSTN) 150, and a partner packet switched network 160 that is accessible through a gateway 162. In addition, the WAN 120 can extend its reach via a host adjacent node 170. One contemplated data service that is provided to the host subscribers is access to the global Internet 180.

In support of fraud monitoring, the fraud detection system 110 supports a number of functions. The fraud detection system 110 provides an interface with external systems; for example, to receive information on monitored activities (e.g., billed connection and failed authentication events) through, for instance, a once-a-day (or more frequently, depending on the application) flat file transfer. The fraud detection system 110 detects and analyzes suspected fraud by applying various detection techniques to user session events, and generating alarms when suspicious patterns are detected. The fraud detection system 110 provides case management by correlating alarms into cases and prioritizing them for analysis; the resultant information can be output to a Graphical User Interface (GUI) in form of Case Summary and Case Detail screens.

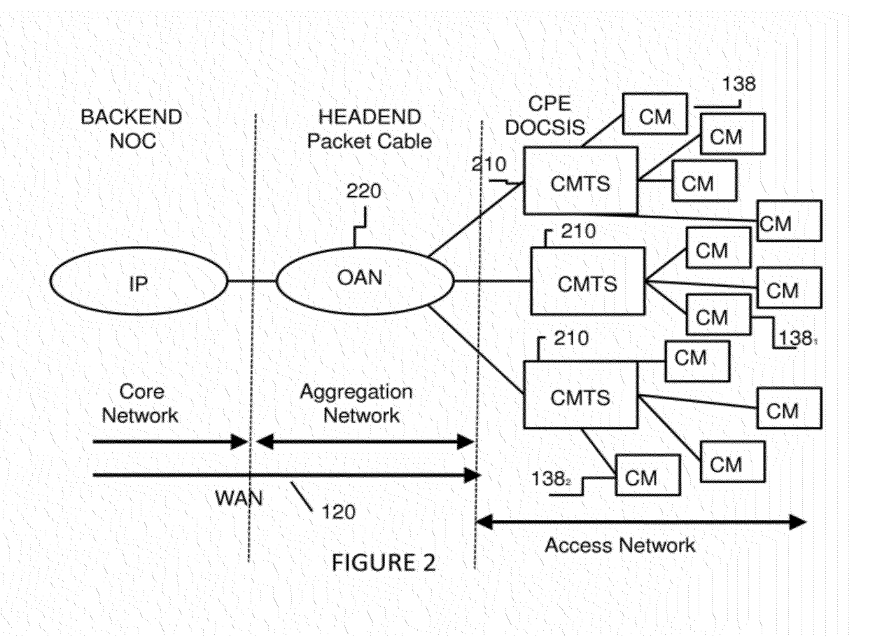

FIG. 2 is another diagram illustrating the relationship between CPE and ISP equipment. To ensure that a CPE is authorized for use on an ISP's network, an authentication processes may be used. The provisioning of the CM 138 is an example of an authentication process. A dynamic host configuration protocol (DHCP) server within the wide area network 120 in conjunction with a CMTS 210 may use the CM 138 MAC address to determine whether a customer is authorized to receive high speed data service via the CM 138 (based on finding the MAC address in a provisioning/authentication database) and what level of service an authorized subscriber is entitled to receive. In a cable network with a single CMTS 210, the CMTS 210 will deny an attempt by a CM 138 to present a MAC address that is currently registered by that CMTS 210. However, if the cable network utilizes multiple CMTSs 210 and if the second use of the MAC address is presented to a CMTS 210 that is not the CMTS 210 that registered the first instance of that MAC address, the duplicated MAC address may not be detected.

The two-way set-top box (STB) is another example of a CMAD that is provisioned by the cable network with an IP address based on the MAC address of the STB. The STB utilizes an integrated cable modem (which is provisioned in the same manner as a standalone CM) to communicate with a DHCP server, and receives its IP address based on the both the integrated CM's and STB's MAC addresses. As described above, a duplicate STB MAC address may operate behind two or more legitimate CM MAC addresses without being detected.

In cable networks comprising regional networks, the detection of multiple MAC addresses from cable network devices is more difficult. CMs, for example, may present the same MAC addresses to different CMTS within a regional network or across different regional networks.

However, embodiments of the present disclosure use an interface that allows a user to load a management information base (MIB), which is a collection of information organized hierarchically, as part of the fraud detection system 110 located within a network operations center (NOC) of the WAN 120. Since large networks comprising a plurality of smaller regional networks employ aggregation networks 220 between the core network and the access network (or last mile), fraud detection systems employed at the NOC can be applied to CMs 138 across a plurality of CMTSs 210.

In certain embodiments, the MIBs are accessed via a network using simple network management protocol (SNMP). There are two types of MIBs which may be used: scalar and tabular. Scalar objects define a single object instance, while tabular objects define multiple related object instances grouped in tables or MIB tables.

Once the MIB is loaded into the application, a reference object identifier (OID) uniquely identifies managed objects in a MIB hierarchy. This can be depicted as a tree, the levels of which are assigned by different organizations. Top level MIB OIDs belong to different standard organizations. Vendors define private branches including managed objects for their own products. This OID can be a traditional top level OID (i.e., a system description) by default, an organizational standard OID (i.e., PsMonitored for HMS/DOCSIS), or a proprietary vendor OID that can be assigned. The reference OID gives the end user flexibility on how tight to set the matching conditions to detect fraudulent devices, as well as adaptability to address any possible changes made by the fraudulent community.

Still with respect to FIG. 2, CMs 138₁ and 138₂, are exemplary of two cable modems on different CMTSs with identical MAC addresses. In this instance, the fraud detection system 110 will identify the duplicate MAC addresses and proceed to compare the system description OID, or other selected OID, of approved CMs with the OIDs of the two CMs 138₁ and 138₂. The CM with a non-matching system description OID will have internet service discontinued while the authorized CM will maintain active service through the ISP.

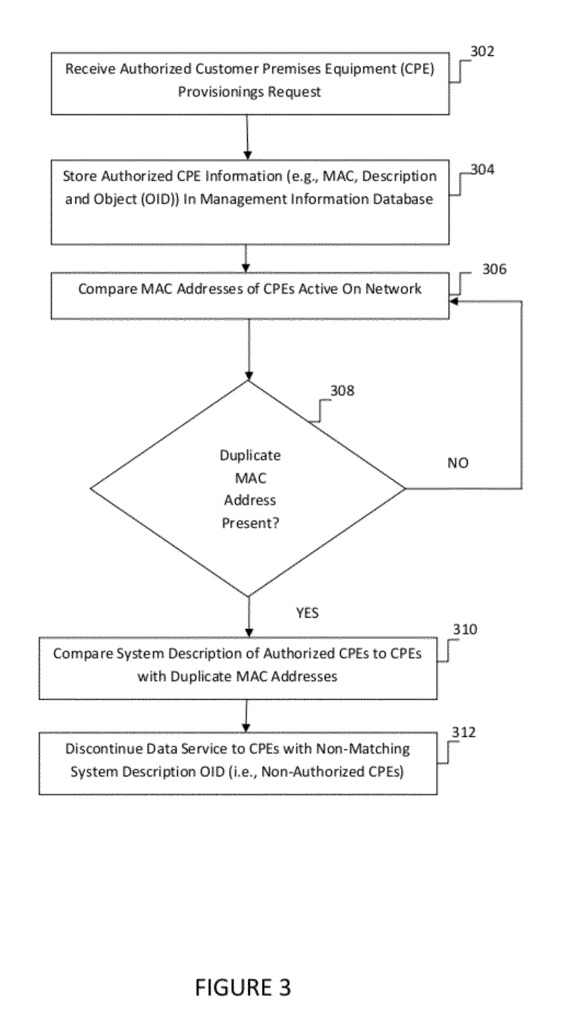

FIG. 3 is a block diagram illustrating a plurality of steps in an exemplary process 300 of detecting and preventing cable fraud. Exemplary process 300 begins at step 302 with the fraud detection system 110 receiving an authorized CPE provisioning request. As previously stated, CPEs may take the form of a cable modem CM, an MTA, or an STB.

At 304, the fraud detection system 110 stores authorized CPE information (e.g., IP address, MAC address, system description OID, CMTS IP address, and domain name of the CMTS) in a management information (MI) database 122.

At 306, the MAC addresses of CPEs active on the network are compared and at 308 it is determined whether there are any duplicate MAC addresses present. If there are no duplicate MAC addresses then the process returns to step 306 to continue comparing MAC addresses of CPEs active on the network.

However, if there are duplicate MAC addresses present, the fraud detection system 110 may compare system description OID of authorized CPEs to the system description OID of CPEs with duplicate MAC addresses, at 310. The comparison of system description OIDs may be executed by sending out an SNMP “GET” request for a particular OID based on the manufacture's MAC address 6 digit prefix which identifies the device type and vendor. If the request is answered, the value is compared to the reference OID initially configured when the device MIB was loaded into the application. In certain embodiments, a second level of security can be added by testing a referenced top level OID as well as a standards based OID.

If the system description OID of an authorized CPE matches the system description OID of a CPE with a duplicate MAC addresses, service is continued. However, if the system description OID of an authorized CPE does not match the system description OID of a CPE with a duplicate MAC addresses, data service is discontinued. Specifically, the CMTS is commanded to release the device provisioning and the fraud detection system 110 bans the MAC address from the CMTS through which the fraudulent CPE is receiving service for a fixed period of time.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. A method for network cable fraud detection, comprising:
receiving via a network an authorized customer premises equipment (CPE) provisioning request;
storing a set of CPE information of an authorized CPE from the provisioning request in a management information database of the network;
determining if there are CPEs active on the network with a duplicate first element of the set of CPE information;
comparing a second, separate and distinct, element of the set of CPE information for each CPE stored in the management information database with the CPEs having the duplicate first element of the set of CPE information, if there are CPEs active on the network with the duplicate first element of the set of CPE information; and
discontinuing data service to each CPE having the duplicate first element of the set of CPE information in which the second element of the set of CPE information does not match the second element of the set of CPE information for any CPE stored in the management information database.

2. The method of claim 1, wherein the set of CPE information stored in the management information database comprises a MAC address and an object identifier (OID) of the CPE.

3. The method of claim 2, wherein the first element of the set of CPE information is the MAC address of the CPE.

4. The method of claim 2, wherein the second element of the set of CPE information is the OID of the CPE.

5. The method of claim 4, wherein the OID of the CPE is a system description OID.

6. The method of claim 1, wherein the CPE is a cable modem

7. The method of claim 1, further comprising continuing data service to each CPE having the duplicate first element of the set of CPE information in which the second element of the set of CPE information does match the second element of the set of CPE information for any CPE stored in the management information database.

8. A computer program product for detecting network cable fraud, the computer-program product comprising a computer readable medium having instructions thereon, the instructions comprising:
instructions for receiving via a network an authorized customer premises equipment (CPE) provisioning request;
instructions for storing a set of CPE information of an authorized CPE from the provisioning request in a management information database of the network;
instructions for determining if there are CPEs active on the network with a duplicate first element of the set of CPE information;
instructions for comparing a second, separate and distinct, element of the set of CPE information for each CPE stored in the management information database with the CPEs having the duplicate first element of the set of CPE information, if there are CPEs active on the network with the duplicate first element of the set of CPE information; and
instructions for discontinuing data service to each CPE having the duplicate first element of the set of CPE information in which the second element of the set of CPE information does not match the second element of the set of CPE information for any CPE stored in the management information database.

9. The computer program product of claim 8, wherein the set of CPE information stored in the management information database comprises a MAC address and an object identifier (OID) of the CPE.

10. The computer program product of claim 9, wherein the first element of the set of CPE information is the MAC address of the CPE.

11. The computer program product of claim 9, wherein the second element of the set of CPE information is the OID of the CPE.

12. The computer program product of claim 11, wherein the OID of the CPE is a system description OID.

13. The computer program product of claim 8, wherein the CPE is a cable modem

14. The computer program product of claim 8, further comprising instructions for continuing data service to each CPE having the duplicate first element of the set of CPE information in which the second element of the set of CPE information does match the second element of the set of CPE information for any CPE stored in the management information database.
